(19) United States
(12) Patent Application Publication
(10) Pub. No.: US 2007/0256599 A1
(43) Pub. Date: Nov. 8, 2007

(54) Inorganic Composite Material And Manufacturing Process

(76) Inventors: Jack Rigsby, Grantsburg, IL (US); Sohan L. Khungar, Woodbridge, IL (US)

Correspondence Address: MCANDREWS HELD & MALLOY, LTD, 500 WEST MADISON STREET, SUITE 3400, CHICAGO, IL, 60661, US

(21) Appl. No.: 11/611,776

(22) Filed: Dec. 15, 2006

Related U.S. Application Data
(60) Provisional application No. 60/750,969, filed on Dec. 16, 2005.

(51) Int. Cl. C04B 12/02

(52) U.S. Cl. 106/690; 366/150.1; 427/331

(57) ABSTRACT

An inorganic composite is formed from a solution of KH₂PO₄ mixed with H₂O, which is then mixed with a metal oxide and a filler material. The mixture of the solution with the metal oxide and filler material forms a flowable slurry. Fibers are then introduced into the slurry. The fibers chemically or mechanically bond with the slurry. The slurry is then cured to form a composite with fibers bonded with the inorganic cement matrix.

### CROSS-REFERENCE TO RELATED APPLICATION(S)

This application relates to and claims priority benefits from U.S. Provisional Patent Application Ser. No. 60/750,969, filed Dec. 16, 2005, entitled “Inorganic Composite Material And Manufacturing Process”. The '969 provisional application is hereby incorporated by reference herein in its entirety.

### FIELD OF THE INVENTION

The present invention generally relates to inorganic composites. In particular, the present invention relates to an inorganic composite and process for making the composite cement.

### BACKGROUND OF THE INVENTION

Acid-base cements such as magnesium phosphate cements are used in many applications. For example, magnesium phosphate cements have been used as patching materials for roads. In addition, acid-base cements such as calcium phosphate and zinc phosphate are also used in dental applications, such as in crowns for teeth. However, acid-base cements currently used are created in a chemical reaction that is highly exothermic. The reaction occurs at a very high reaction rate. Therefore, it is currently difficult to create large batches of acid-base cements such as magnesium phosphate cements. As it is difficult to create large amounts of these cements, it is also difficult to use the cements in applications where a large amount of the cements are required. For example, in the construction industry, it is currently difficult, if not impossible, to use current systems and methods for creating building panels (such as panels for the outside walls of buildings, floor panels, and roof panels) made of magnesium phosphate cements.

Current magnesium phosphate cements exhibit large compressive strengths, but typically weak tensile and flexural strengths. Therefore, such cements may not be useful in applications where materials experience large tensile forces. For example, building panels such as floor panels and roof panels experience a large compressive load on the top, or load-bearing side, and large tensile forces on the opposite side of the panels. Therefore, it is difficult to fabricate floor and/or roof panels using currently available magnesium phosphate cements, as these cements may not be capable of withstanding the tensile forces typically experienced in roof and floor panels.

Current systems and methods for producing magnesium phosphate cements incorporate chopped fibers such as polypropylene fibers into the cement to provide for increased strength. However, these fibers tend to act as crack inhibitors and provide very little additional tensile and flexural strength to the cement.

Moreover, current fibers used in the cements do not chemically bond with the cement and leave voids between the chopped fibers and the surrounding cement. These voids can decrease the actual strength of the cement below its potential strength. In other words, while the incorporation of fibers can increase cement's tensile and flexural strength, the increase in strength can be increased even more if chemical and/or mechanical bonding existed between the fibers and the cement.

Therefore, a need exists for a composite that exhibits increased compressive, flexural, and tensile strength. In addition, a need exists for a procedure for making such a composite that can be produced on a large scale sufficient for producing large structures.

### SUMMARY OF THE INVENTION

A composite is formed from a solution of KH₂PO₄ mixed with H₂O, which is then mixed with a metal oxide and a filler material. The mixture of the solution with the metal oxide and filler material forms a flowable slurry. Fibers are then combined with the slurry. The fibers can chemically and/or mechanically bond with the slurry. The slurry is then cured to form a composite with fibers bonded with the inorganic cement matrix.

### BRIEF DESCRIPTION OF THE DRAWINGS

FIG. 1 illustrates a mixing system for creating the composite described above in accordance with an embodiment of the presently described technology.

FIG. 2 illustrates a system for continuous processing of an inorganic composite in accordance with an embodiment of the presently described technology.

FIG. 3 illustrates a mat of basalt and e-glass fibers in accordance with an embodiment of the presently described technology.

FIG. 4 illustrates a mat of e-glass fibers in accordance with an embodiment of the presently described technology.

FIGS. 5A, 5B and 5C illustrate a spool of fibers and four strands of fibers in accordance with an embodiment of the presently described technology.

FIG. 6 illustrates a honeycomb structure that can be used as a mat in accordance with an embodiment of the presently described technology.

FIG. 7 illustrates two portions of ballistic armor created in accordance with an embodiment of the presently described technology.

FIG. 8 includes a graph illustrating increasing compressive strength versus curing or setting time in accordance with an embodiment of the presently described technology.

FIG. 9 includes a histogram illustrating compressive strength for a composite and cured in various conditions in accordance with an embodiment of the presently described technology.

FIG. 10 includes a histogram illustrating compressive strength for a composite cured under various conditions in accordance with an embodiment of the presently described technology.

FIG. 11 illustrates a plan view of a vertical support member used in a building panel that is formed of the composite material in accordance with an embodiment of the presently described technology.

FIG. 12 illustrates an isometric view of a vertical support member used in a building panel that is formed of the composite material in accordance with an embodiment of the presently described technology.

FIG. 13 illustrates a flowchart of a method for creating an inorganic composite material in accordance with an embodiment of the presently described technology.

FIG. 14 illustrates an SEM image of an inorganic composite formed in accordance with an embodiment of the presently described technology.

FIGS. 15A, 15B and 15C include SEM images of an inorganic composite formed according to an embodiment of the presently described technology.

FIG. 16 illustrates system with a continuous mixing system in accordance with an embodiment of the presently described technology.

FIGS. 17A and 17B illustrate several detailed examples of continuous mixing systems according to embodiments of the presently described technology.

### DETAILED DESCRIPTION OF PREFERRED EMBODIMENT(S)

The present composite comprises a chemically bonded ceramic matrix and a fiber. The ceramic matrix comprises a cement formed of an acid-base reaction between a metal-oxide and a phosphate. In a preferred embodiment of the present composite cement, the phosphate is KH₂PO₄ (or potassium phosphate). In another embodiment, the phosphate is ammonium phosphate. In a preferred embodiment of the present composite cement, MgO is reacted with KH₂PO₄. The reaction is described as:
MgO+KH₂PO₄+5H₂O→MgKPO₄.6H₂O (1)

KH₂PO₄ is blended with H₂O. The resulting pH of the KH₂PO₄ and H₂O solution is approximately 4.5. Next, the monopotassium phosphate and H₂O are mixed to make a supersaturated solution in equilibrium with the K⁺ and PO₄⁻ ions in the solution. After mixing for approximately 5-15 minutes, the MgO is added. The mixing time can be reduced if the particle size is decreased, and therefore, the total surface area is increased. The mixing time can also be reduced if high shear mixing is used.

The MgO is in powder form and preferably has experienced some degree of calcination. For example, in accordance with embodiments of the present composite cement, the MgO may be one or more of calcinated MgO (referred to herein as “dead burn” MgO), Mag10CR MgO (referred to herein as “hard burn” MgO), or “lite burn” MgO. In general, dead burn MgO has experienced a larger amount of calcination relative to hard burn MgO and lite burn MgO, hard burn MgO has experienced a larger amount of calcination relative to lite burn MgO, and lite burn MgO has experienced a larger amount of calcination relative to non-calcinated MgO. The amount of calcination for MgO can be used to affect the reaction rate of the resultant cement, as described in more detail below. In general, a larger amount of calcination results in a lower reactivity for the MgO. In addition, a larger amount of calcination decreases the porosity of the individual MgO grains.

In addition to adding MgO to the solution, a filler can be added to the solution. For example, C-fly ash can be used as a filler. Other types of materials that can be used as a filler include sand (such as quartz, silica, or torpedo sand, for example), glass (such as recycled glass, for example), and/or iron slag, for example. In a preferred embodiment, the filler is a metal-oxide based filler that provides for chemical bonding between the filler material and the cement.

Both the MgO and the fly ash are preferably added slowly to the solution. The solution with the MgO and fly ash are then mixed thoroughly. The solution, MgO and fly ash are preferably mixed in a high shear mixer until a flowable slurry is obtained. For example, in order to obtain a flowable slurry, the solution, MgO and fly ash can be mixed in a high shear mixer for at least 6-8 minutes.

A metal oxide other than MgO can be used. The type of metal oxide can be selected based on various chemical and physical properties of the metal oxide. For example, Cu₂O can be used in place of MgO to provide antibacterial properties to the ceramic concrete. Such properties can be advantageous in applications for the ceramic concrete where it is desirable to inhibit bacterial growth. Hospital floors and walls, and countertops and floors in kitchens and restaurants are applications where such properties are desired, for example.

However, other metal oxides can also be employed in place of MgO and/or Cu₂O. For example, TiO₂, Al₂O₃, Fe₂O₃ and/or CaO could also be used. In addition, a combination of metal oxides can be used.

In addition, one or more metal oxides other than MgO can be used to replace a portion of the MgO used. For example, instead of replacing all of the MgO in a ceramic concrete, only a fraction of the total MgO used can be replaced by another metal oxide. In another example, a combination of metal oxides other than MgO can be used to partially or completely replace the MgO normally used in the ceramic concrete. By using a combination of metal oxides, various physical and chemical properties of the metal oxides can be obtained in the final ceramic concrete.

One or more fillers can be used to replace all or a portion of the fly ash used in the ceramic concrete described above. For example, glass spheres (for example, cenospheres), lightweight aggregates, and calcium silicate (for example, wollastonite) could be used to replace all or a part of the C-fly ash filler described above. The lightweight aggregates can include glass (such as recycled glass, for example). In another example, all or a portion of the filler can be replaced with entrained or entrapped air. By replacing all or a portion of the filler with entrained air, glass spheres and/or lightweight aggregates, the weight of the ceramic concrete can be reduced.

In order to increase the flexural and tensile strength of the ceramic concrete described herein, fibers can be incorporated into the ceramic concrete to form an inorganic ceramic composite material. In order to provide for chemical bonding between the ceramic concrete material and the fibers, a fiber that includes metal oxide and/or other materials adapted to chemically bond with metal oxide can be used. As described above, by using a metal oxide and a filler that includes metal oxide and/or other materials adapted to chemically bond with metal oxide in the cement, chemical bonds can be formed between the metal oxide and the filler. Similarly, by using a fiber that includes metal oxide and/or other materials adapted to chemically bond with metal oxide, the metal oxide, the filler and the fibers can provide for chemical bonding between the various components of the ceramic composite material, such as the metal oxide, the filler and the fibers.

In an embodiment, there can be mechanical bonding between any one or more of the ceramic, filler, and fibers.

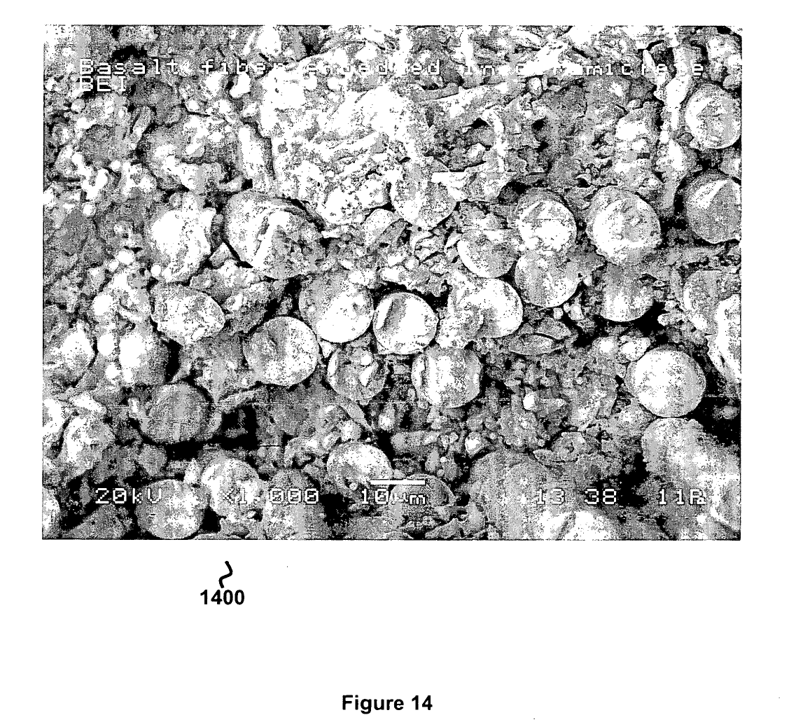

In a preferred embodiment of the present composite cement, basalt fibers can be used as fibers. FIG. 14 illustrates a scanning electron microscope (SEM) image 1400 of an inorganic composite formed in accordance with an embodiment of the presently described technology. The composite sample of image 1400 includes basalt fibers. In another embodiment of the presently described technology, another fiber such as e-glass, s-glass, Kevlar, polytetrafluoroethylene (trade name Teflon) fibers, carbon fibers, aramid fibers, ceramic fibers or metal fibers, such as whiskers, strands, mesh, or rebar, can be used. Basalt fibers are preferred for their relatively low price but high tensile and flexural strength. For example, while basalt fibers can have approximately 30% of the tensile strength of carbon fibers, basalt fibers can be obtained at a much lower cost.

In a preferred embodiment of the presently described technology, the fibers are in a continuous form. For example, the fibers can extend in a continuous strand along a dimension of a structure or object formed with the composite material described herein. Such a dimension can include, for example a length of a building panel formed by the composite. However, continuous fibers can also extend across dimensions of structures or objects. For example, a continuous fiber can extend at an angle across a length, width and/or height of a structure or object formed by the ceramic concrete. Continuous fibers can be layed in layers and patterns such that fibers are in different and all directions, giving strength in all directions.

Continuous fibers can be formed in one or more shapes. In a preferred embodiment, fibers can be woven into a mat. A mat of fibers includes a woven mat of fibers to be incorporated into the ceramic concrete described above. The mat fibers can include one or more of the fibers described above. For example, the mat can include a combination of the fibers described above. A mat can include fibers woven at an angle of approximately 90° with respect to each other. Alternatively, fibers in a mat are woven at angles other than approximately 90° with respect to each other. By adjusting the angle between the various directions of fibers in a mat, the directions in a structure formed by the inorganic composite possessing the largest structural strength can be customized. In other words, the fibers in a mat can be arranged to provide increased flexural and tensile strength in one or more directions, or in all directions.

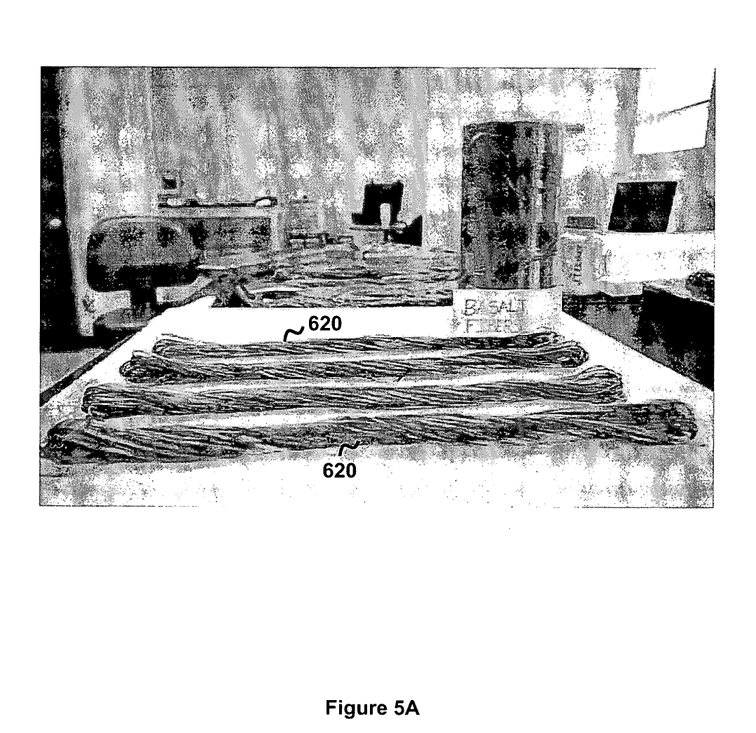

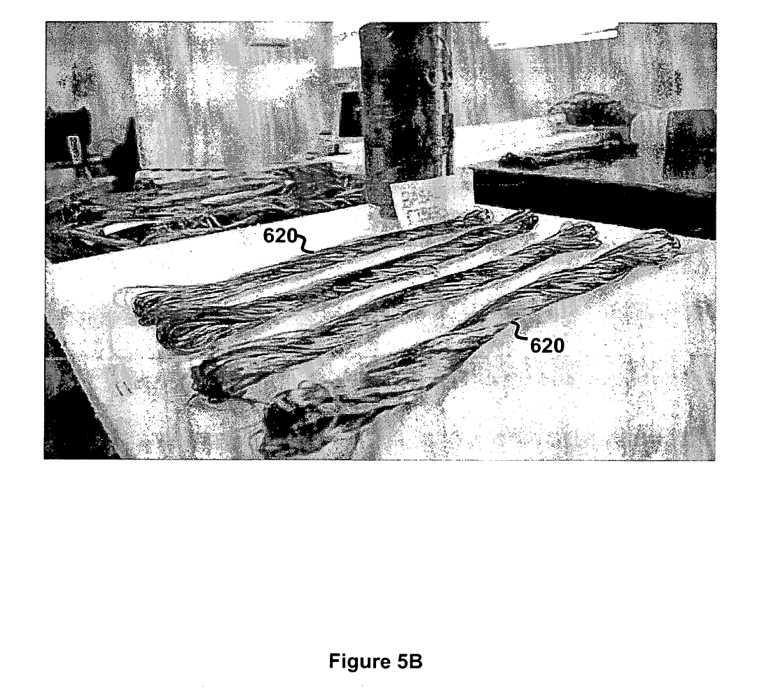

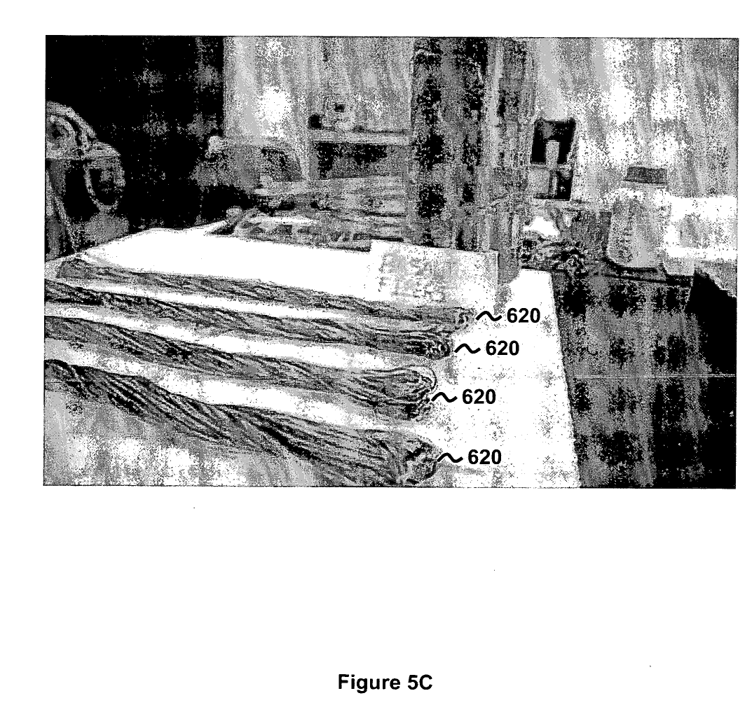

A mat can be formed from a plurality of strands of fibers. In other words, a plurality of fiber strands can be woven so as to create a mat. The fibers can be stored on one or more spools, similar to the storage of yarn or string. FIGS. 5A, 5B and 5C illustrate a spool 610 of fibers and four strands 620 of fibers in accordance with an embodiment of the presently described technology. Basalt fibers can be stored on spool 610 and/or in strands 620. The thickness of a strand 620 of fibers can be altered by including a greater or fewer number of individual fibers in strand 620.

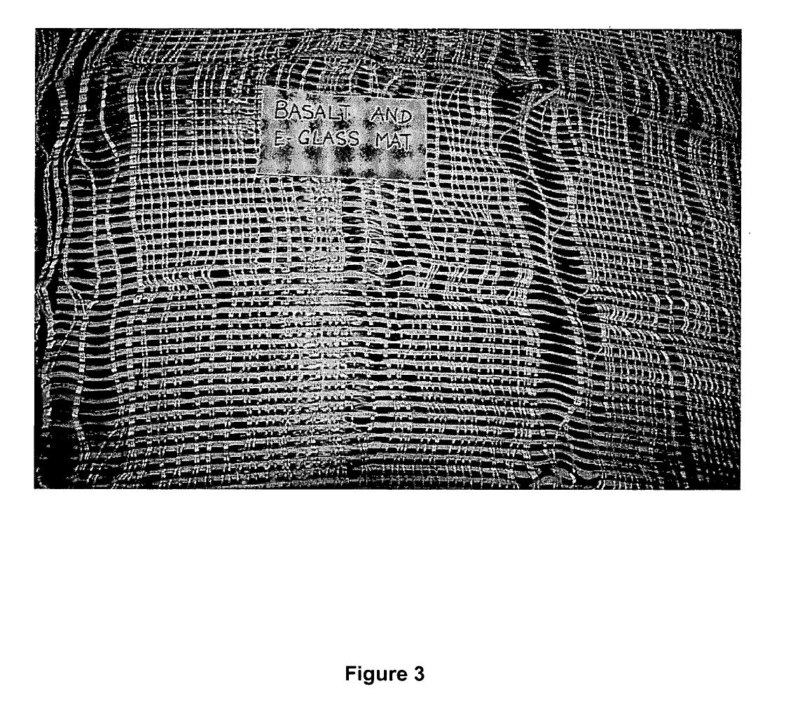

FIG. 3 illustrates a mat of basalt and e-glass fibers in accordance with an embodiment of the presently described technology. The basalt and e-glass fibers of the mat in FIG. 3 are woven at approximately 90° with respect to each other. In addition, the basalt and e-glass fibers are woven so that the basalt fibers run in one direction, while the e-glass fibers run in a direction approximately 90° with respect to each other.

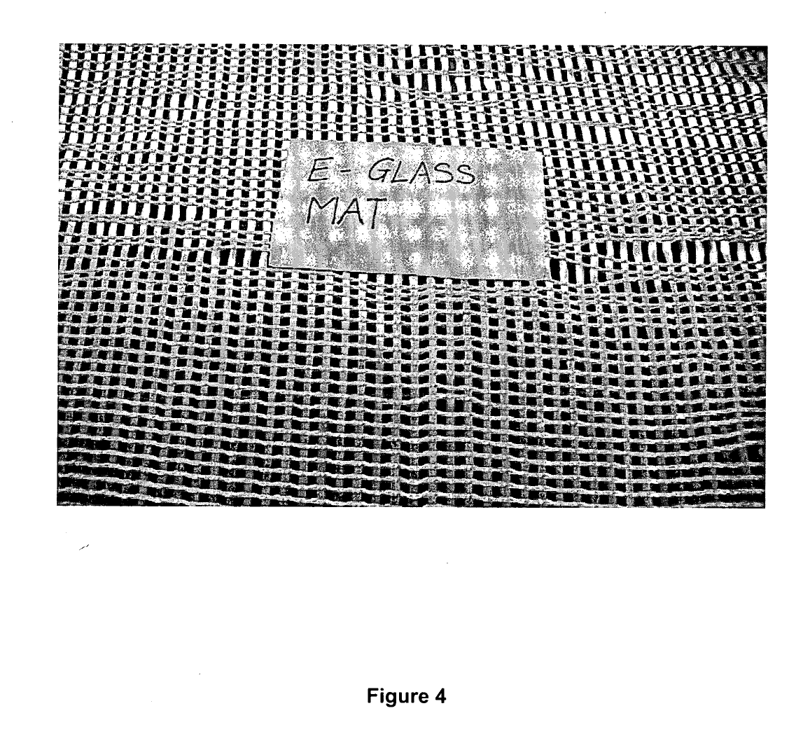

FIG. 4 illustrates a mat of e-glass fibers in accordance with an embodiment of the present composite cement. The e-glass fibers of the mat in FIG. 4 are woven at approximately 90° with respect to each other.

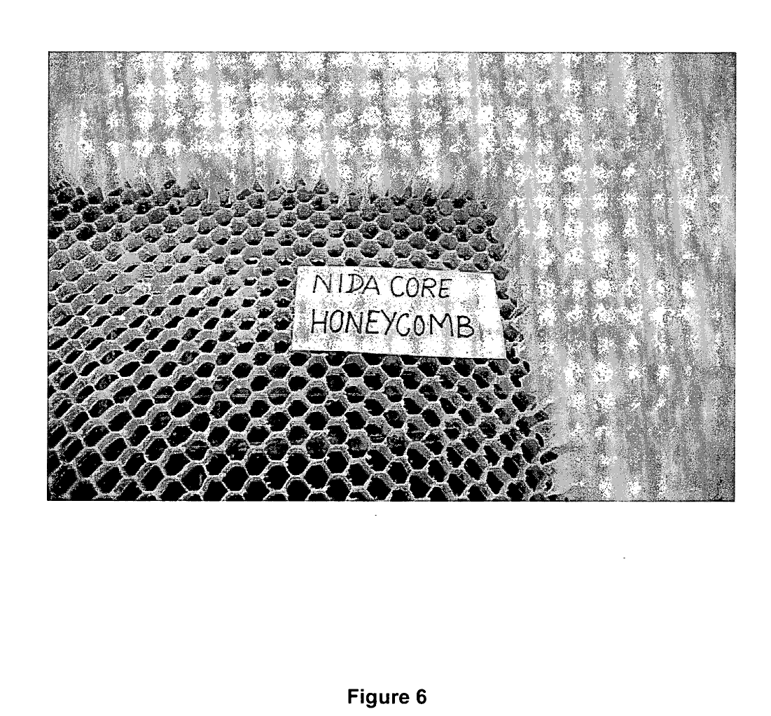

A honeycomb structure can be used in place of a mat of fibers. FIG. 6 illustrates a honeycomb structure that can be used as a mat in accordance with an embodiment of the present composite cement. The honeycomb structure can be formed of a material such as aluminum or polypropylene. For example, the honeycomb structure can be formed of Nida core material.

In another embodiment, the fibers can be non-continuous. For example, the fibers may be segmented into lengths shorter than a dimension of an object or structure formed with the composite material described herein. Such fibers may be referred to as “chopped” fibers, for example.

In order to increase the strength of the inorganic composite, a wetting agent can be used to decrease the surface tension of the fibers prior to incorporating the fibers into the ceramic concrete. For example a wetting agent such as Mg(OH)₂, K₂HP₄O, and/or a surfactant can be used to “wet” the fibers prior to incorporation into the ceramic concrete. By decreasing the surface tension of the fibers, the degree of chemical bonding between the metal oxide, filler and fibers can be increased. Polyvinyl alcohol, polyacrylates, polyethylene oxide/glycol and/or other additions to surfactants can also be used to enhance the bond strength between the fiber and the matrix. Water Glass, a solution of potassium silicate and sodium silicate in water, can also be used on the interface between the fibers and the cement.

In addition, the percentage of fiber volume used in the composite material can be increased to increase the tensile and flexural strength of the composite. The percentage of fiber volume is the fraction or amount of volume of the composite material that comprises fibers. For example, the fiber volume can vary from 10% to 40%. However, a larger or smaller fiber volume can also be used.

The fibers can be incorporated into the ceramic concrete by various methods. For example, the fibers can be placed into a mold. The ceramic concrete can then be poured into the mold and allowed to cure with the fibers, as described in more detail below. Once the ceramic concrete has cured for a desired amount of time, an inorganic composite is obtained.

In another embodiment of the presently described technology, the fibers can be impregnated with the ceramic concrete by pouring the ceramic concrete onto the fibers followed by applying pressure to the ceramic concrete and fibers, as described in more detail below. For example, the ceramic concrete can be poured onto the fibers prior to passing the ceramic concrete and fibers through one or more rollers designed to apply compressive pressure to impregnate the fibers with the ceramic concrete. The ceramic concrete and fibers can then be allowed to cure as described in more detail below.

As described above, the reaction between the metal oxide, filler and solution is highly exothermic and therefore occurs very quickly. Therefore, in general, the composite should generally be formed only in small batches. As a consequence, it can be difficult to form large structures and objects with the composite material described above. For example, by creating the composite material in a batch form, it can be difficult or impossible to create structures such as concrete building panels with the composite material. However, such structures can be created using a continuous processing system and method described below in accordance with an embodiment of the presently described technology.

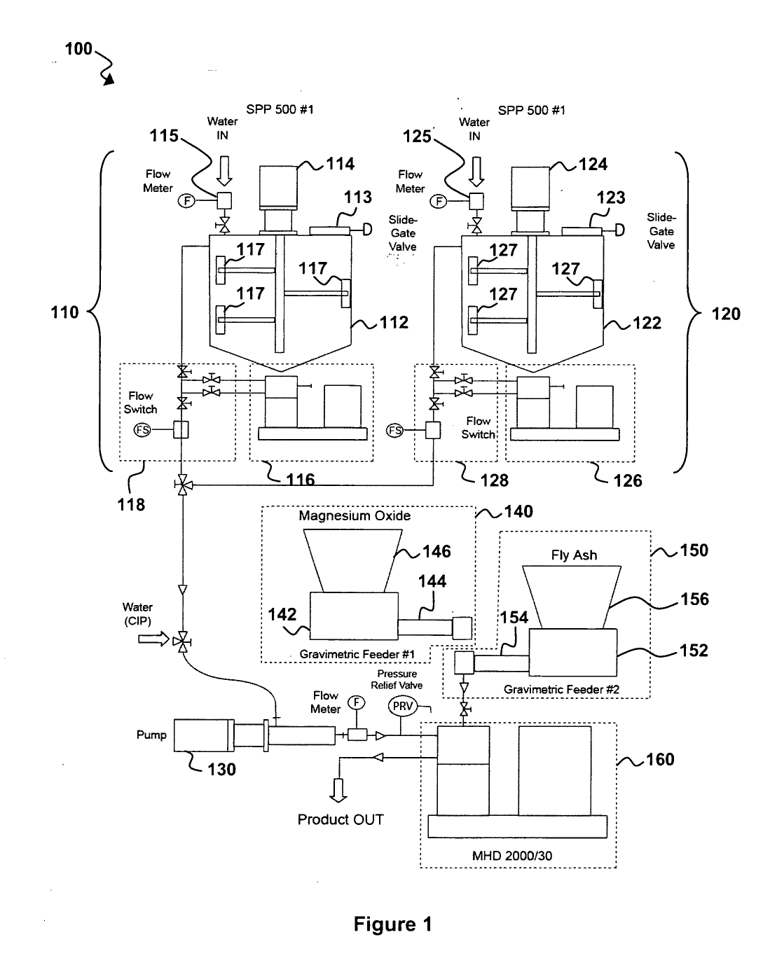

FIG. 1 illustrates a mixing system 100 for creating the composite described above in accordance with an embodiment of the presently described technology. System 100 includes a first mixing system 110, a second mixing system 120, a pump 130, a first feeder 140, a second feeder 150, and a powder/liquid mixing system 160. First mixing system 110 includes a vessel 112, a stirrer 114, a disperser 116, and a circulation loop 118. Second mixing system 120 includes a vessel 122, a stirrer 124, a disperser 126, and a circulation loop 128. First feeder 140 includes a rate module 142, a feed module 144, and a hopper module 146. Second feeder 150 includes a rate module 152, a feed module 154, and a hopper module 156.

In operation, first and second mixing systems 110, 120 are configured to mix the phosphate and water of the ceramic concrete. For example, first and second mixing systems 110, 120 are configured to mix KH₂PO₄ and H₂O prior to introducing MgO, as described above by Equation #1. By including two mixing systems 110, 120, while one system discharges the KH₂PO₄+H₂O solution downstream in system 100, the other system can continue to mix the next batch of the solution. A flow switch can be used to indicate when a vessel 112, 122 of either mixing system 110 or 120 has been emptied. At that point, a three-way valve can switch the supply of the solution to the other vessel 112 or 122.

As described above, the KH₂PO₄ is blended with H₂O for approximately 5 to 15 minutes. The KH₂PO₄ can be fed into vessel 112, 122 of first and/or second mixing system 110, 120 through a slide-gate valve 113, 123 present on each of first and second vessel 112, 122. The H₂O can be fed into vessel 112, 122 of first and/or second mixing system 110, 120 through a water feed valve 115, 125 present on each of first and second vessels 112, 122. Water feed valve 115, 125 can include a magnetic flow meter. The water can be metered into vessels 112, 122 by totalizing the flow through the magnetic flow meter and an automatic valve.

Vessels 112, 122 can each be capable of holding a sufficient amount of solution to provide for the continuous processing of the ceramic concrete described herein. For example, vessels 112, 122 can each include a volume of 500 liters (useful) and 650 liters (actual). Vessels 112, 122 can be formed of a non-reactive material. For example, vessels 112, 122 can be formed of stainless steel AISI 316L.

Once the H₂O and KH₂PO₄ are present in first and/or second vessels 112, 122, stirrer 114, 124 and disperser 116, 126 operates to mix the H₂O and KH₂PO₄ in each respective vessel 112, 122. Stirrers 114, 124 each include a motor drive to cause respective dispersers 116, 126 to spin. For example, stirrers 114, 124 can include a motor running on 3 kW and capable of operating at 1800 rpm with an output of approximately 35 grams per minute (gpm).

A plurality of mixing blades 117, 127 are attached or mounted to a shaft or other structure connecting blades 117, 127 to stirrer 114 or 124. Stirrers 114, 124 mix the solution of H₂O and KH₂PO₄ in each respective vessel 112, 122 by spinning blades 117, 127.

Once the solution is mixed, the KH₂PO₄ can be partially dissolved in the water. Once the KH₂PO₄ and H₂O are mixed into a solution, the solution flows from vessel 112, 122 to respective disperser 116, 126. In other words, the solution mixed in vessel 112 flows to disperser 116 while the solution mixed in vessel 122 flows to disperser 126.

Dispersers 116, 126 are configured to disperse the KH₂PO₄ and H₂O solution to the remainder of system 100 and/or back into a respective vessel 112, 122. In other words, disperser 116 can disperse the solution back into vessel 112 or into the remainder of system 100 and disperser 126 can disperse the solution back into vessel 122 or into the remainder of system 100. Each disperser 116, 126 can include a motor for dispersing or pumping the solution. For example, each disperser 116, 126 can include a three-phase motor, running on 7.4 kW, with an output of approximately 5800 rpm/60 Hz. Each disperser 116, 126 can also include mixing tools such as a generator/motor for pumping or dispersing the solution. Each disperser 116, 126 can be formed of a non-reactive material such as stainless steel AISI 316L.

One or more dispersers 116, 126 can include a heating and/or cooling jacket. Such a jacket is configured to heat and/or cool a disperser 116, 126 enclosed in the jacket. A jacket can be employed to heat or cool the KH₂PO₄+H₂O solution before dispersing or pumping it to the remainder of system 100. By cooling the solution before pumping it to the remainder of system 100, the rate of reaction when the metal oxide and filler powders are mixed with the solution can be decreased and controlled.

The solution next flows from disperser 116 and/or disperser 126 to a respective circulation loop 118, 128. In other words, once the solution leaves disperser 116, the solution flows to circulation loop 118 while solution leaving disperser 126 flows to circulation loop 128.

Each circulation loop 118, 128 includes a plurality of valves configured to direct the solution from a disperser 116, 126 to a respective vessel 112, 122 or from a disperser 116, 126 to pump 130. For example, circulation loop 118 is configured to cause the solution to flow from disperser 116 to vessel 112 or from disperser 116 to pump 130. Similarly, circulation loop 128 is configured to cause the solution to flow from disperser 126 to vessel 122 or from disperser 126 to pump 130, for example. Circulation loop 118, 128 can re-circulate the solution back to a respective vessel 112, 122. In other words, the solution can be re-circulated from vessel 112, 122 to disperser 116, 126 to circulation loop 118, 128 back to vessel 112, 122. Alternatively, one or more valves in circulation loop 118, 128 can be adjusted to direct the solution to pump 130.

Circulation loops 118, 128 can each include tubing made of a non-reactive material (such as 316L stainless steel with 1.5″ diameter) and a plurality of valves (such as pneumatically operated ball valves).

System 100 includes two mixing systems 110, 120 so as to allow the continuous production of the KH₂PO₄+H₂O solution. In other words, while one batch of mixed solution is flowing from vessel 112 to disperser 116 to circulation loop 118 to pump 130, another batch of the solution can be mixing in vessel 122 and/or re-circulating from vessel 122 to disperser 126 to circulation loop 128 to vessel 122, as described above, for example. Similarly, while one batch of mixed solution is flowing from vessel 122 to disperser 126 to circulation loop 128 to pump 130, another batch of the solution can be mixing in vessel 112 and/or re-circulating from vessel 112 to disperser 116 to circulation loop 118 to vessel 112, for example.

One or more mixing systems 110, 120 can be enclosed in a vacuum. For example, one or more of mixing systems 110, 120 can be enclosed in a volume that includes an atmosphere with air pressure less than ambient air pressure. In such an embodiment, vacuum surrounding either mixing system 110, 120 can be a partial or total vacuum.

The solution can be pulled from mixing system 110 and/or 120 to the remainder of system 100 by pump 130. Pump 130 can include a motor such as a 3-phase motor capable of operating at 3 horsepower (HP) and 3600 revolutions per minute (rpm) with an output of approximately 140 rpm, 60 Hertz.

The solution can then pass into powder/liquid mixing system 160. Powder/liquid mixing system 160 is configured to allow for continuous incorporation and dispersing of powders (such as a metal oxide and a filler) into liquids (such as a solution formed from KH₂PO₄+H₂O). Mixing system 160 includes a mixing tool, a motor, and a cooling system. The mixing tool includes an auger. The motor can be a 60 HP, 230-460 Volt, 3-phase motor operating at 60 Hz, 1800 rpm, for example. The motor and mixing tool are configured to mix the powers and solution in a high shear mix until a flowable slurry is obtained.

In an embodiment, mixing system 160 can be enclosed in a vacuum. For example, mixing system 160 can be enclosed in a volume that includes an atmosphere with air pressure less than ambient air pressure. In such an embodiment, vacuum surrounding mixing system 160 can be a partial or total vacuum. Such a vacuum can assist with removing air voids or pockets existing in the ceramic slurry before the composite completes curing or setting.

In an embodiment, system 160 also can include a positive displacement pump for metering and pumping the KH₂PO₄+H₂O solution. System 160 can also include a magnetic flow meter for measuring the flow of the solution. System 160 can also include two loss-in-weight feeders for feeding and metering the metal oxide and/or filler powders.

The heating/cooling system includes an internal heating/cooling coil capable of heating or cooling the slurry. The heat exchange system can be employed to heat or cool the slurry. As described above, the reaction described by Equation (1) is exothermic and occurs at a high rate. Therefore, the cooling system can be used to slow the reaction rate by cooling the slurry. Alternatively, if a faster reaction rate is desired, the heating/cooling system can be used to heat the slurry, thereby increasing the reaction rate of the slurry.

The metal oxide powder is fed into powder/liquid mixing system 160 by first feeder 140. As described above, first feeder 140 includes rate module 142, feed module 144, and hopper module 146. First feeder 140 is configured to supply the metal oxide powder into powder/liquid mixing system 160 at a desired rate. For example, first feeder 140 can include a gravimetric feeder. A gravimetric feeder is a feeder designed to adjust an amount of powder supplied to powder/liquid mixing system 160 based on the amount of powder remaining in feeder 140. For example, at a first time t₀, feeder 140 includes a mass m₀ of the metal oxide powder. At t₁, feeder 140 includes a mass m₁ of the metal oxide powder. Therefore, a feed rate for feeder 140 can be determined as (m₀−m₁)/(t₀−t₁). Based on this feed rate, feeder 140 can increase or decrease the amount of metal oxide supplied to powder/liquid mixing system 160 so as to provide a constant or desired feed rate of the metal oxide powder. First feeder 140 can include an automatic slide gate valve that can be pulsed in order to control the flow of the metal oxide powder into mixing system 160.

First feeder 140 can be formed of a non-reactive material, such as polyurethane and/or stainless steel. For example, the parts of first feeder 140 that are in contact with the metal oxide can be formed of 304SS and polyurethane.

Scale module 142 of feeder 140 is configured to determine a mass and/or weight of the metal oxide powder remaining in feeder 140. For example, scale module 142 can include a load cell such as a digital load cell.

Feed module 144 of feeder 140 is configured to feed the metal oxide powder into powder/liquid mixing system 160 at a constant or desired rate. Feed module 144 may be capable of feeding the metal oxide powder in an extruded manner. For example, feed module 144 can include a single screw feeder driven by a motor. The motor can drive the screw, which feeds the powder out of first feeder 140 into mixing system 160.

Hopper module 146 includes a volume capable of holding the metal oxide powder. Hopper module 146 can include an open bottom to allow metal oxide powder to flow into feed module 144. In addition, hopper module 146 can include a lid so as to allow additional powder to be fed into module 146.

The filler is fed into powder/liquid mixing system 160 by second feeder 150. As described above, second feeder 150 includes rate module 152, feed module 154, and hopper module 156. Similar to first feeder 140, second feeder 150 is configured to supply the filler into powder/liquid mixing system 160 at a desired rate. For example, second feeder 150 can include a gravimetric feeder similar to first feeder 140.

Second feeder 150 can be formed of a non-reactive material, such as polyurethane and/or stainless steel. For example, the parts of second feeder 150 that are in contact with the metal oxide can be formed of 304SS and polyurethane.

Scale module 152 of feeder 150 is configured to determine a mass and/or weight of the filler remaining in feeder 150. For example, scale module 152 can include a load cell such as a digital load cell.

Feed module 154 of feeder 150 is configured to feed the filler into powder/liquid mixing system 160 at a constant or desired rate. Feed module 154 may be capable of feeding the filler in an extruded manner, similar to feed module 144. For example, feed module 154 can include a single screw feeder driven by a motor. The motor can drive the screw, which feeds the powder out of second feeder 150 into mixing system 160.

Hopper module 156 includes a volume capable of holding the filler. Hopper module 156 can include an open bottom to allow filler to flow into feed module 154. In addition, hopper module 156 can include a lid so as to allow additional filler to be fed into module 156.

Once the KH₂PO₄+H₂O solution, metal oxide, and filler are incorporated into mixing system 160, the solution, metal oxide and filler are mixed in a high shear mix until a flowable slurry is obtained, as described above. Once the slurry is obtained, the slurry is output from system 100.

As described above, the slurry can now be poured into a mold to form a ceramic cement. The mold can also include fibers to be incorporated into the ceramic composite so as to form an inorganic composite, also as described above.

As described above, the reaction defined by Equation (1) is exothermic and occurs at a high reaction rate. Therefore, only small objects can be formed using batch processing of the composite material. However, using continuous processing, larger objects, such as girders, floor panels, roof panels, and countertops can be formed from the composite material.

In addition and in accordance with various embodiments of the presently described technology, the reaction rate can be decreased by one or more methods. For example, the rate of the reaction defined by Equation (1) can be decreased by cooling the KH₂PO₄+H₂O solution and/or the slurry formed by the solution mixed with metal oxide and filler powders. For example, as described above, cooling jackets and/or systems can be used to cool the solution and/or slurry.

The reaction rate can also be reduced by using a metal oxide that has undergone a larger amount of calcination. As described above, various forms of MgO (such as dead, hard and light burn MgO) react at different rates. By selecting a form of MgO with a larger amount of calcination, the reaction rate can be decreased.

The reaction rate can also be reduced by using room temperature or colder water when mixing the KH₂PO₄+H₂O solution. Similar to the use of cooling jackets and/or systems as described above, by using room temperature or colder water, the reaction rate can be decreased.

The reaction rate can also be reduced by adding a multi-protonic acid. The multi-protonic acid acts as a pH buffer. The acid may coat the metal oxide and blocks the phosphate in the KH₂PO₄+H₂O solution from reaching the metal oxide and immediately reacting with it. In other words, the acid acts as a fuse in that the phosphate “eats through” the acid coating on the metal oxide before reacting with the metal oxide, thereby slowing the rate of reaction. For example, boric acid can be added to coat the metal oxide. In another example, citric acid can be used. Citric acid can also provide additional benefits. The citric acid causes the ceramic slurry to flow more evenly and impregnate the fibers more. Tartaric acid can also be used.

The reaction rate can also be decreased by decreasing the amount of metal oxide used in the mixture. In addition, the rate of adding the metal oxide to the solution can also be decreased to decrease the reaction rate.

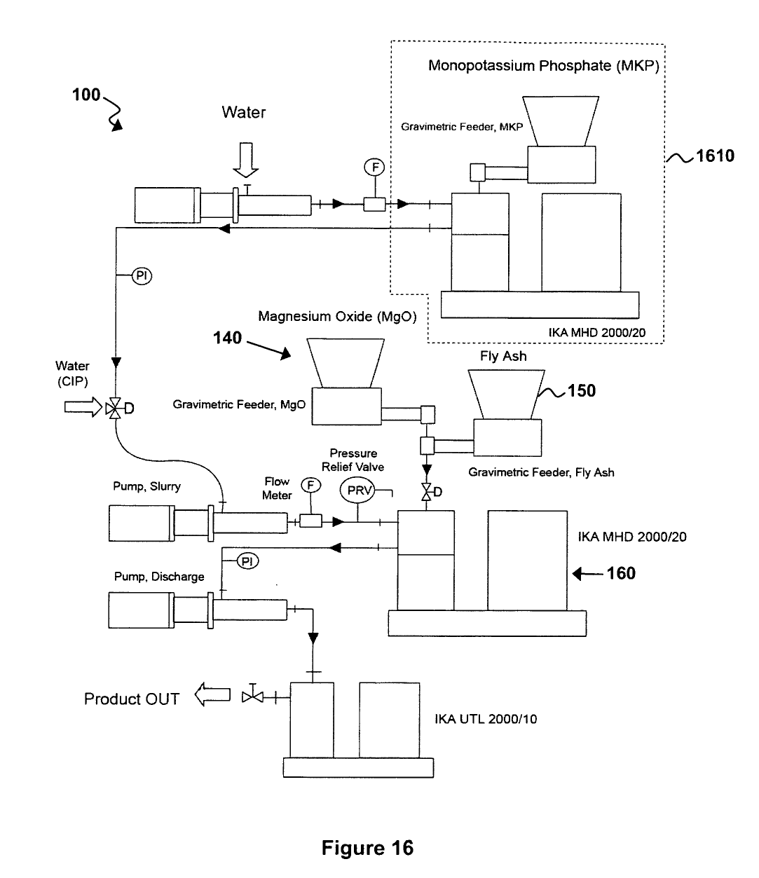

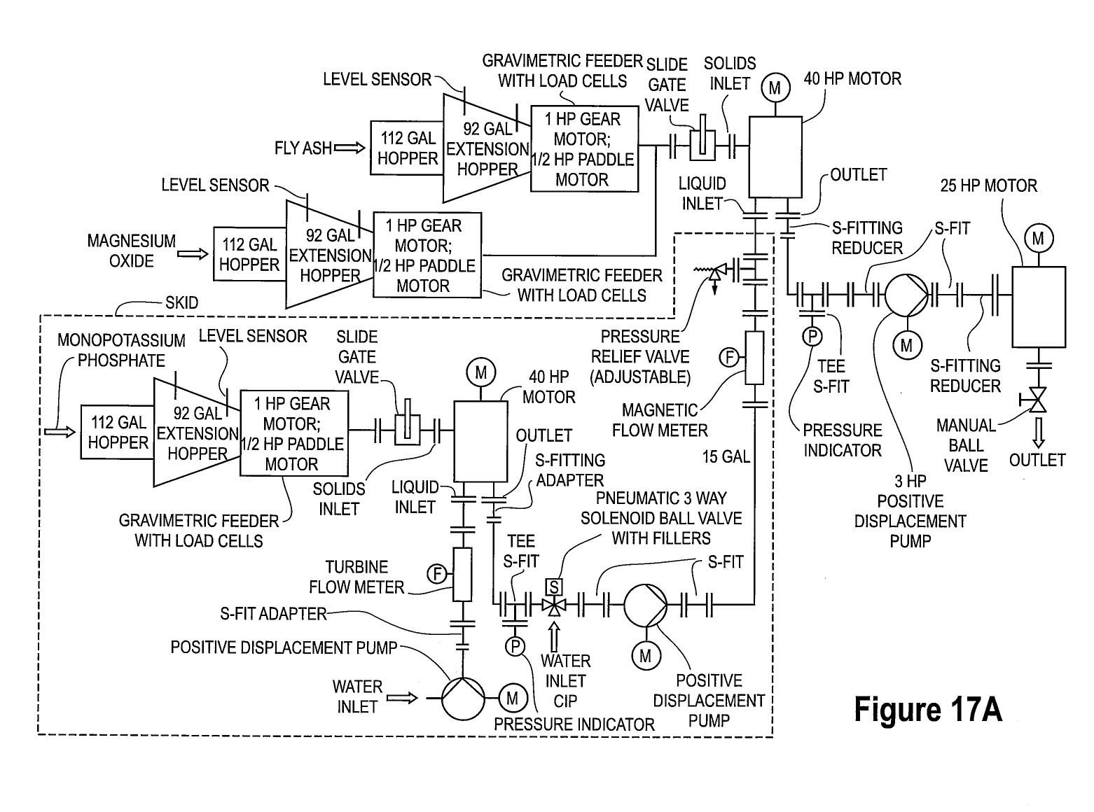

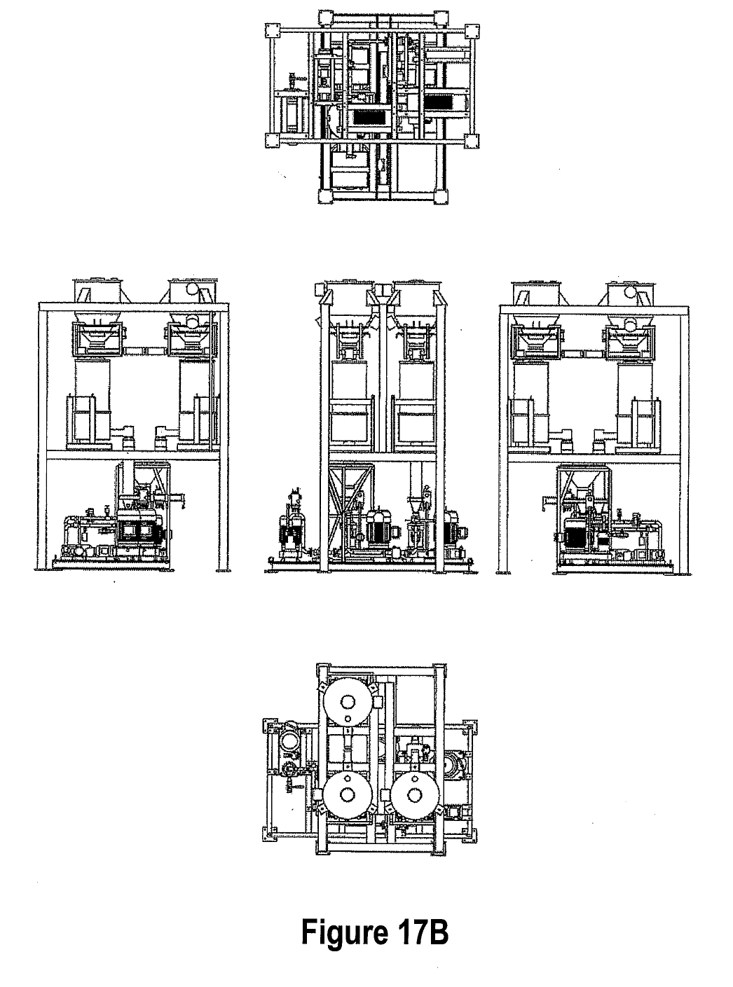

In an embodiment of the presently described technology, mixing systems 110, 120 are replaced with a continuous mixing system. FIG. 16 illustrates system 100 with a continuous mixing system 1600 in accordance with an embodiment of the presently described technology. System 1600 is used to continually mix H₂O and a phosphate, such as monopotassium phosphate. System 1600 can include a gravimetric feeder that continually supplies the phosphate to the water at a constant rate, similar to the gravimetric feeders described above. By using system 1600 in system 100, the cement matrix can be continually prepared using a single system, rather than through a series of batches using systems 110, 120 described above. Additionally, processing parameters can be optimized using the continuous mixing system 1600. For example, the mixing times described above can be reduced from several minutes to just a few seconds. FIGS. 17A and 17B illustrate several detailed examples of continuous mixing systems according to embodiments of the presently described technology.

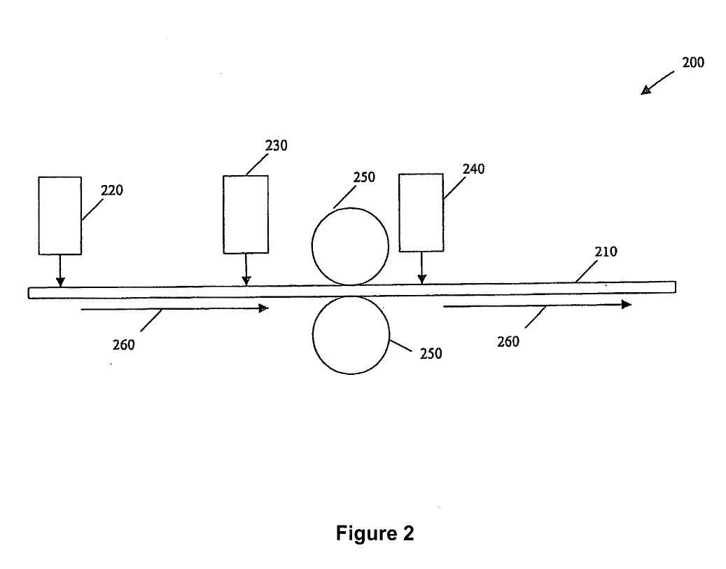

Fibers can be incorporated into the ceramic concrete formed by system 100 in a continuous manner in order to create an inorganic composite. FIG. 2 illustrates a system 200 for continuous processing of an inorganic composite in accordance with an embodiment of the presently described technology. System 200 includes a wetting agent applicator 220, a first slurry applicator 230, a second slurry applicator 240, and a plurality of rollers 250.

A mat 210 of fibers includes a woven mat of fibers to be incorporated into the ceramic concrete, as described above. The ceramic concrete is the matrix of the inorganic composite material. Mat 210 provides increased flexural strength to composite structures formed with the ceramic concrete and fibers.

As illustrated in FIG. 2, mat 210 moves through system 200 in the direction shown by direction arrows 260. Mat 210 first passes under wetting agent applicator 220. Wetting agent applicator 220 applies a wetting agent in a continuous manner to mat 210. As described above, the wetting agent is used to decrease the surface tension of fibers in mat 210 prior to incorporating the fibers into the ceramic concrete. Examples of wetting agents include Mg(OH)₂, K₂HP₄O (potassium phosphate) or other surfactant. Wetting agent applicator 220 can apply the wetting agent to mat 210 by spraying the wetting agent onto mat 210 or by physically rolling or brushing the wetting agent onto mat 210. The amount of wetting agent applied to mat 210 can be varied by adjusting the speed at which mat 210 passes under wetting agent applicator 220 and/or by adjusting the rate at which the wetting agent is expelled from wetting agent applicator 220.

Mat 210 next passes under first slurry applicator 230. First slurry applicator 230 applies the ceramic concrete slurry in a continuous manner to mat 210. As described above, the metal oxide, potassium phosphate, water and filler are mixed in a high shear mix until a flowable slurry is obtained. The slurry can be supplied to first slurry applicator 230 from mixing system 100 described above. First slurry applicator 230 can apply the ceramic slurry to mat 210 by pouring the slurry onto mat 210 or by physically rolling or brushing the slurry onto mat 210. The amount of ceramic slurry applied to mat 210 can be varied by adjusting the speed at which mat 210 passes under first slurry applicator 230 and/or by adjusting the rate at which the slurry is poured or otherwise expelled from first slurry applicator 230.

Mat 210 next passes between rollers 250. Rollers 250 include a rounded surface capable of applying compressive pressure to mat 210 and the slurry applied by first slurry applicator 230. For example, rollers 250 can be embodied in a non-reactive material shaped in a cylindrical form. In such an example, rollers 250 can be utilized in a manner similar to dough rollers. Rollers 250 can therefore rotate in opposite directions (such as the top roller 250 rotating in a counter-clockwise direction and the bottom roller 250 rotating in a clockwise direction) in order to compress the slurry and mat 210. By applying pressure, the fibers in mat 210 become impregnated with the slurry.

One or more of first slurry applicator 210 and rollers 250 can be enclosed in a vacuum as mat 210 passes under and through each one. For example, first slurry applicator 210 and/or rollers 250 can be enclosed in a volume that includes an atmosphere with air pressure less than ambient air pressure. In such an embodiment, the vacuum surrounding first slurry applicator 210 and/or rollers 250 can be a partial or total vacuum. Such a vacuum can assist with removing air voids or pockets existing in the ceramic slurry as the slurry is impregnated into the fibers of mat 210.

Once mat 210 and the slurry passes rollers 250, mat 210 and slurry next passes under second slurry applicator 240. Second slurry applicator 240 applies additional ceramic concrete slurry in a continuous manner to mat 210. As described above, the metal oxide, potassium phosphate, water and filler are mixed in a high shear mix until a flowable slurry is obtained. The slurry can be supplied to second slurry applicator 240 from mixing system 100 described above. Similar to first slurry applicator 230, second slurry applicator 240 can apply the ceramic slurry to mat 210 by pouring the slurry onto mat 210 or by physically rolling or brushing the slurry onto mat 210. The amount of ceramic slurry applied to mat 210 can be varied by adjusting the speed at which mat 210 passes under second slurry applicator 240 and/or by adjusting the rate at which the slurry is poured or otherwise expelled from second slurry applicator 240.

Additional slurry is provided by second slurry applicator 240 to provide a uniform thickness to mat 210 and slurry. After passing through rollers 250, mat 210 and slurry can have a non-uniform thickness and/or a non-uniform surface (that is, a rough surface). By applying additional slurry, the final composite material can possess a more uniform thickness and/or surface.

After passing second slurry applicator 240, mat 210 and slurry is placed into a position of rest. In other words, the mat 210 and slurry stops moving. Once mat 210 and slurry stops moving, the ceramic concrete slurry can set or cure. For example, an entire mat 210 can pass through system 200 before coming to rest to cure or set. Once mat 210 and slurry has set or cured, an inorganic composite is formed, as described above. The composite can then be cut to a desired shape or length.

In another example, mat 210 and slurry can pass through system 200 continually and mat 210 and slurry are cut into desired shapes or lengths as mat 210 and slurry pass beyond second slurry applicator 240. In other words, once a desired amount of mat 210 and slurry have passed second slurry applicator 240, mat 210 is cut. The portion of mat 210 and slurry that is separated from the remainder of mat 210 in system 200 is then placed in a position of rest to cure or set, as described above.

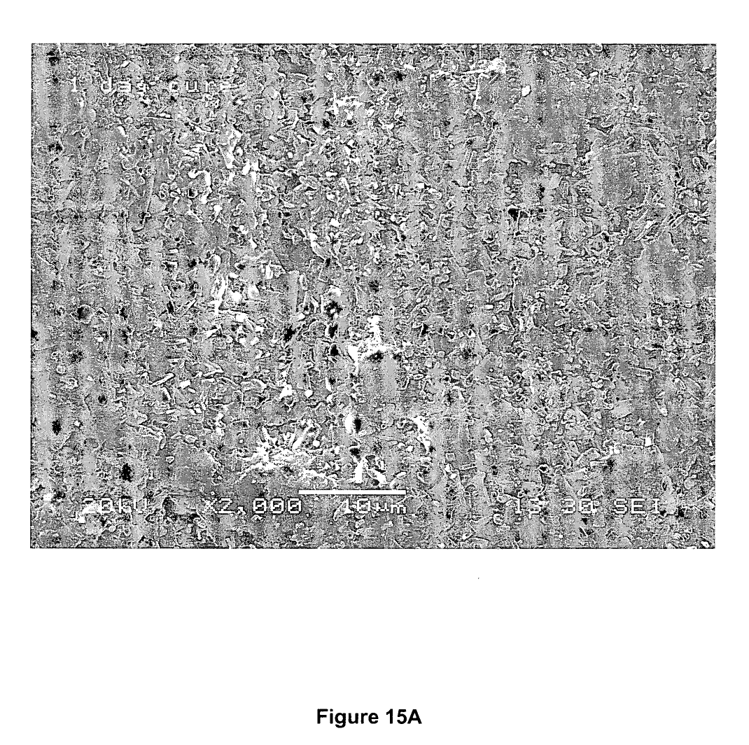

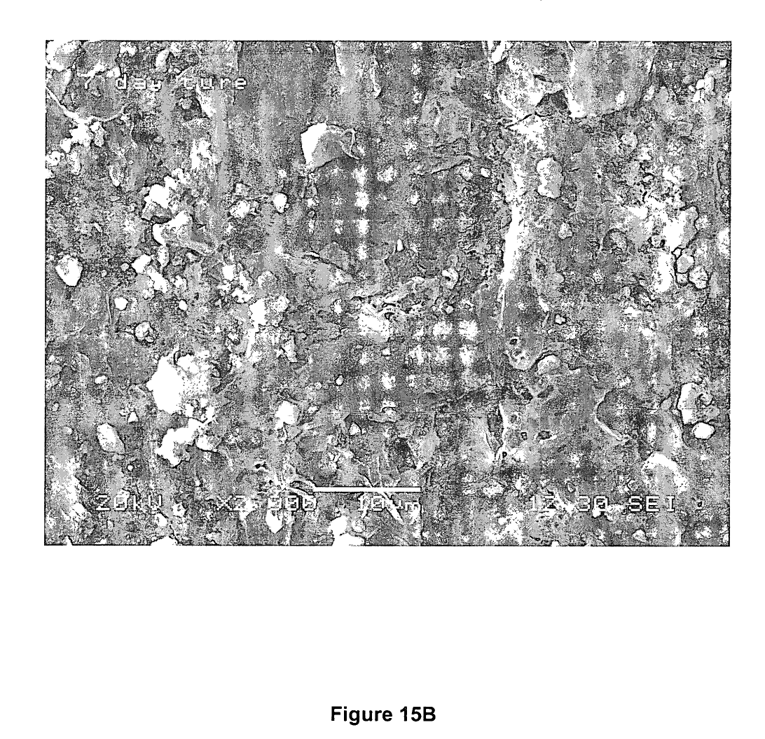

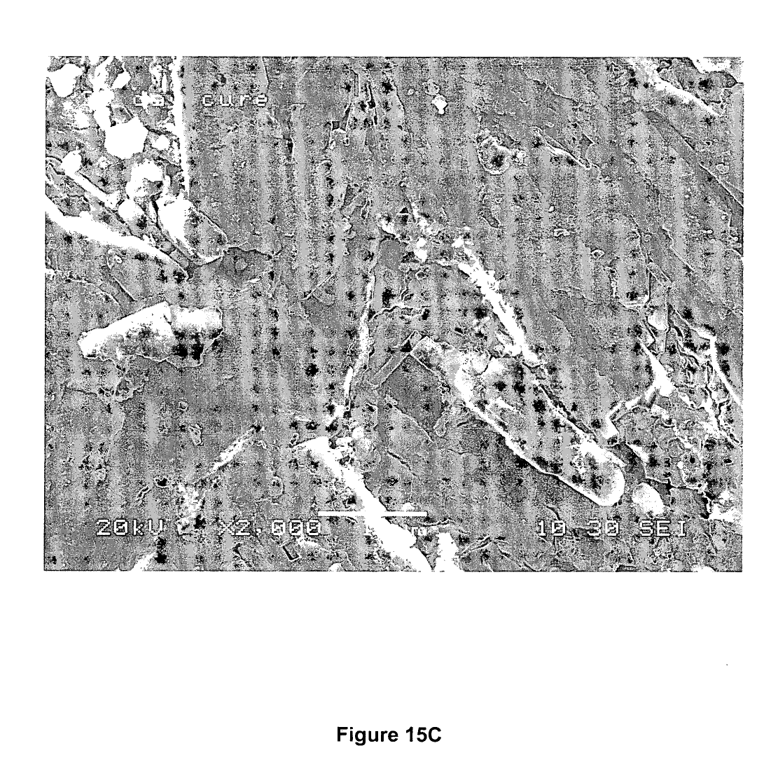

The inorganic composite formed by mat 210 and the slurry sets or cures to form a rigid structure. The chemical reaction is highly exothermic and forms a crystalline material. Typically, the longer the composite is permitted to cure, the higher the density and degree of crystallinity in the composite. In other words, the density and crystallinity of the composite increases with increasing curing time. FIGS. 15A, 15B and 15C include SEM images of a composite formed according to an embodiment of the presently described technology. The sample featured in the image of FIG. 15A has cured for 1 day. The sample featured in the image of FIG. 15B has cured for 7 days. The sample featured in the image of FIG. 15C has cured for 28 days. As shown in the images, the longer the curing time, the higher degree of crystallinity and density in the composite material.

In general, the longer the composite is permitted to cure, the greater the compressive strength the composite possesses. For example, the compressive strength of the composite can increase from approximately 10,000 pounds per square inch (psi) (68,948 kilopascals (kPa)) after 1 day of curing at room temperature to approximately 15,500 psi (103,421 kPa) after 28 days of curing at room temperature. However, several other factors can impact the compressive strength of the composite ceramic, such as the absence (or presence) of defects in the ceramic concrete. Such defects can include, for example, cracks, voids, and unreacted lumps of materials in the ceramic concrete.

Structures created with the composite cement described herein exhibit increased tensile and flexure strengths. Composites described herein have been measured to possess flexural strengths on the order of 6000 psi (41,369 kPa) to 7000 psi (48,263 kPa) and upwards.

Depending on the amount of curing time, various physical and chemical properties of the composite are obtained. For example, once the composite is set, a closed pore composite is obtained. In general, by increasing setting or curing time, the percentage of closed pores in the composite also increases. A closed pore composite material can be useful when the material is used with a steel structure. For example, if the composite material is used in a building panel and steel trusses are incorporated in the material, by preventing moisture from reaching the steel, the composite material prevents corrosion of the steel trusses. For example, the composite can comprise a 99% closed pore material that absorbs approximately 1% water. The composite and/or ceramic concrete can therefore be used as a coating over other structures or materials that corrode when exposed to water or humidity. In addition, by incorporating steel such as steel trusses into the composite material, the steel can be protected from corrosion.

In addition, the composite cement can cure in air. Alternatively, the composite cures while immersed in water after an initial cure in air.

The composite can cure at room temperature. Alternatively, the composite cures at an elevated temperature. An elevated temperature can include a temperature greater than room temperature. For example, an elevated temperature can be approximately 86° F. (30° C.) to approximately 110° F. (43.3° C.).

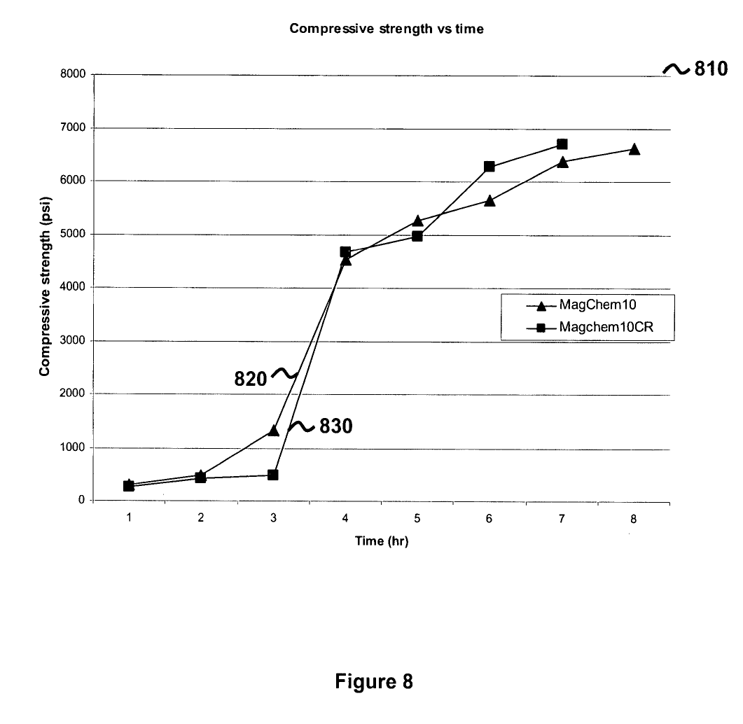

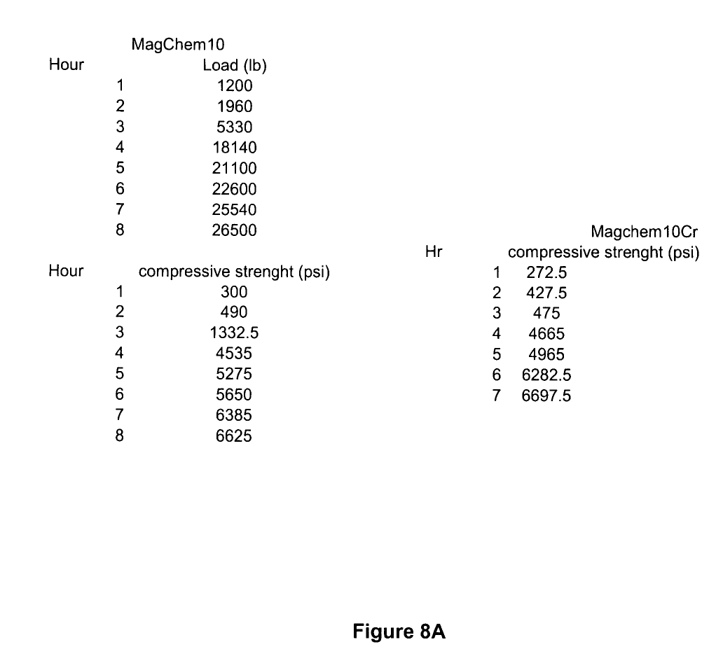

FIG. 8 includes a graph 810 illustrating increasing compressive strength versus curing time in accordance with an embodiment of the presently described technology. Graph 810 includes two data lines 820, 830. Data line 820 represents the compressive strength of the inorganic composite described herein that was created using MagChem10 as the MgO powder. Data line 830 represents the compressive strength of the inorganic composite described herein that was created using MagChem10CR as the MgO powder. As illustrated by graph 810, for both forms of MgO used in the composite, the compressive strength increases with increasing curing time.

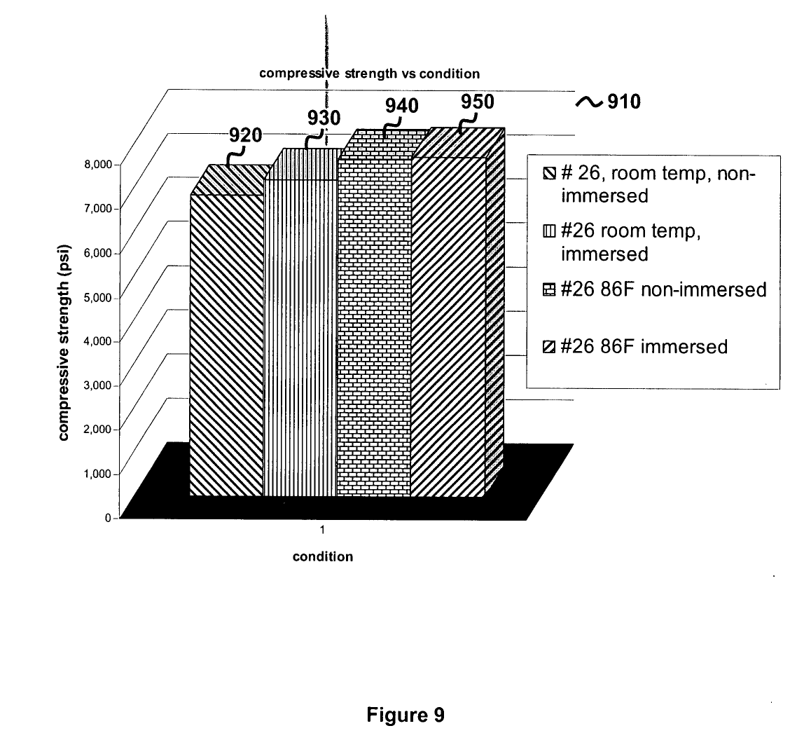

In addition, curing the composite under various conditions can also increase its compressive strength. In other words, curing the composite at elevated temperatures, or temperatures above room temperature, and/or immersing the composite in water during curing after an initial cure in air increases the compressive strength of the composite when compared to curing at room temperature. FIG. 9 includes a histogram 910 illustrating compressive strength for a composite and cured in various conditions in accordance with an embodiment of the presently described technology. Histogram 910 four bars 920 through 950. Bar 920 represents the compressive strength of the composite that was cured at room temperature in the air (that is, not immersed in water or in a vacuum). Bar 930 represents the compressive strength of the composite that was cured at room temperature and immersed in water. Bar 940 represents the compressive strength of the composite that was cured at an elevated temperature of 86° F. (30° C.) and not immersed in water. Bar 950 represents the compressive strength of the composite that was cured at an elevated temperature of 86° F. (30° C.) and immersed in water.

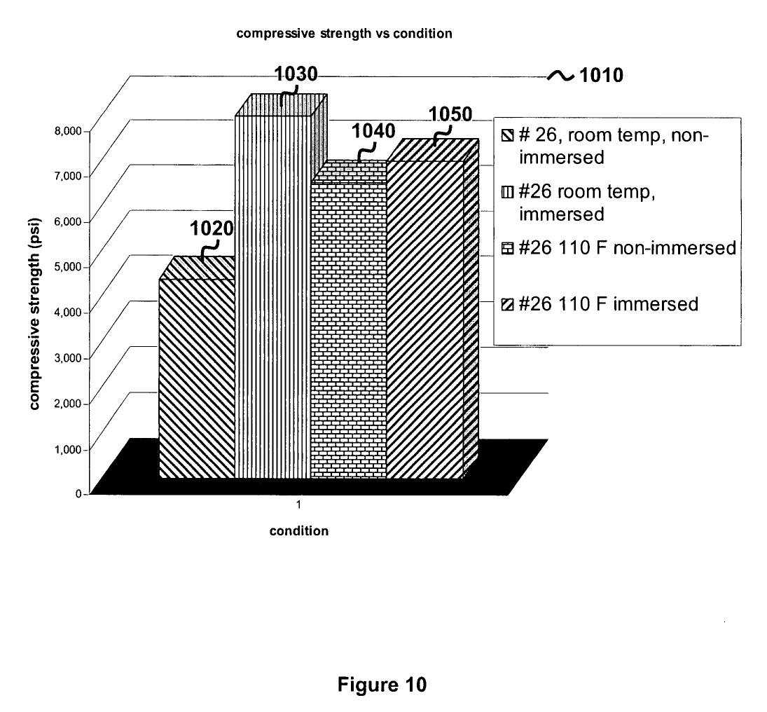

FIG. 10 includes a histogram 1010 illustrating compressive strength for a composite cured under various conditions in accordance with an embodiment of the presently described technology. Histogram 1010 four bars 1020 through 1050. Bar 1020 represents the compressive strength of the composite that was cured at room temperature in the air. Bar 1030 represents the compressive strength of the composite that was cured at room temperature and not immersed in water. Bar 1040 represents the compressive strength of the composite cement that was cured or set at an elevated temperature of 110° F. and not immersed in water. Bar 1050 represents the compressive strength of the composite that was cured at an elevated temperature of 110° F. (43.3° C.) and immersed in water.

As illustrated in histograms 910 and 1010, curing the composite at an elevated temperature can increase its compressive strength. In addition, immersing the composite in water during curing can also increase its compressive strength.

One or more curing agents can be added to the water in which the composite cures (after an initial cure in air). For example, phosphoric acid, a phosphate (such as dipotassium phosphate) and a water soluble metal oxide (such as magnesium hydroxide) could be used.

The inorganic composite can be used in a structure where a large compressive strength and large tensile and flexural strength is desired. In addition, composites created in accordance with embodiments of the presently described technology can also exhibit increased fire resistance when compared to steel. Therefore, the composite described herein is particularly useful in creating building panels such as roof and floor panels. For example, in concrete roof panels and floor panels used in buildings, the top of the panels typically experience a compressive load while the bottom of the panels typically experiences a tensile load. By incorporating the composite described herein into floor and roof panels, the added tensile and flexural strength achieved by the composite allows for less total weight in the panel.

Moreover, the increased tensile and flexural strength of the composite can provide for lighter building panels. For example, as the composite is stronger than traditional cements used in building panels that incorporate steel trusses. As the composite materials described herein can achieve the same or increased tensile or flexural strength as traditional cements with steel trusses, panels formed of the composite materials can be significantly lighter.

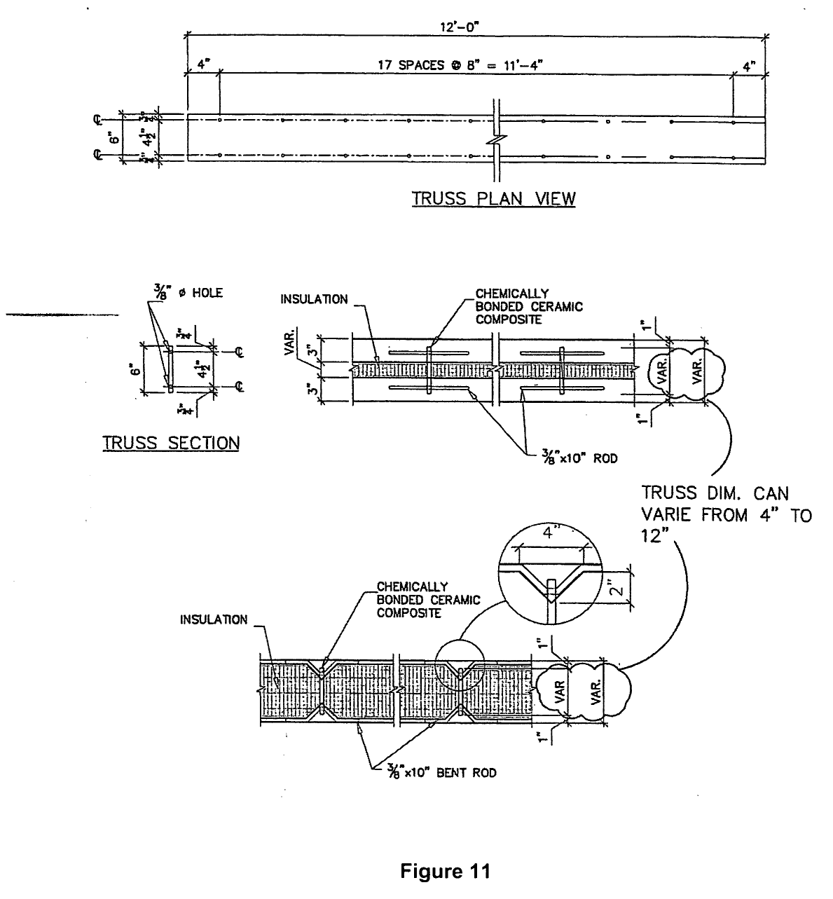

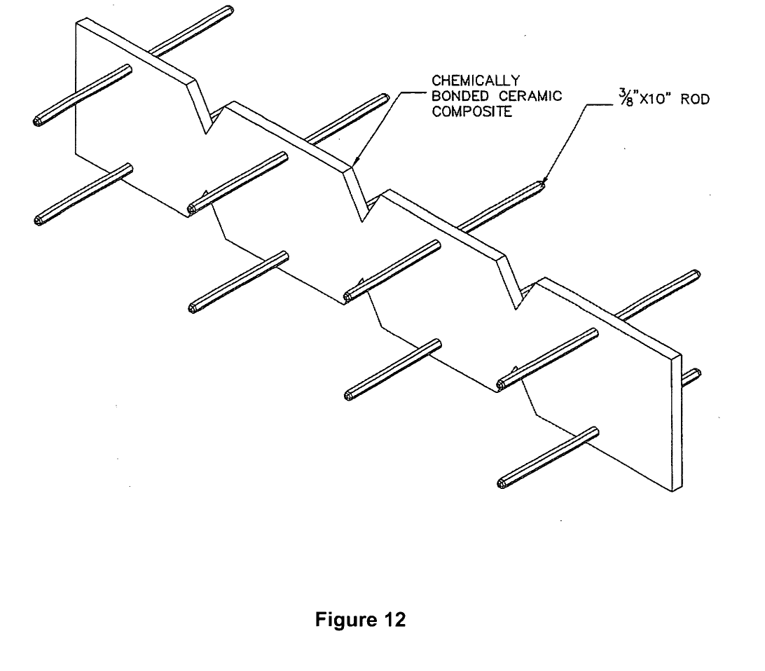

In another example, the composite material can be used as vertical support members, or trusses, in a building panel. FIG. 11 illustrates a plan view of a vertical support member used in a building panel that is formed of the composite material in accordance with an embodiment of the presently described technology. FIG. 12 illustrates an isometric view of a vertical support member used in a building panel that is formed of the composite material in accordance with an embodiment of the presently described technology. The composite can be a useful replacement for vertical support members or trusses made of steel as the composite materials do not corrode (as steel does) and have increased resistance to fire (over steel and existing concretes).

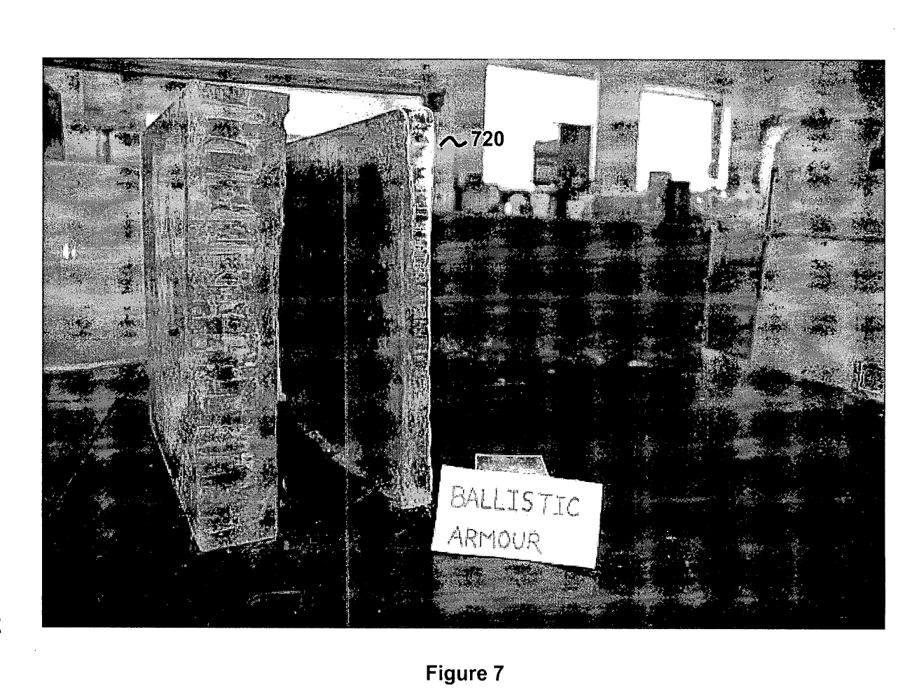

The inorganic composite can also be used for ballistic armor. In order to create such ballistic armor, one or more toughening agents can be added to or is used as a partial replacement for the metal oxide powder. A toughening agent can include, for example, B₄C or BN. The resultant composite material can then be used as a front wall to ballistic armor and acts as a hardened shield. FIG. 7 illustrates two portions of ballistic armor created in accordance with an embodiment of the presently described technology. Portion 710 of the ballistic armor was created using a honeycomb structure with MgO powder and B₄C added to the powder. Portion 710 acts as a hardened shield upon an impact of ballistics or shrapnel on portion 710. Portion 720 acts as a backing wall for the ballistic armor. Portion 720 was created using mat 210 formed by e-glass fibers and the ceramic concrete described herein. A layer of polymer can be placed between portions 710 and 720 to absorb the impact of ballistics on the armor. For example, a layer of polyurethane can be placed between portions 710 and 720.

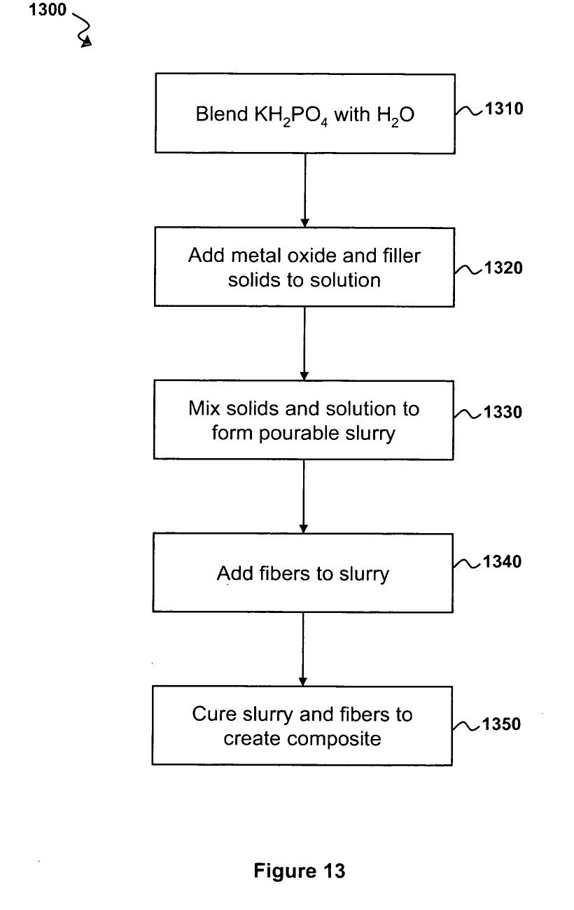

FIG. 13 illustrates a flowchart of a method 1300 for creating a composite material in accordance with an embodiment of the presently described technology. First, at step 1310, KH₂PO₄ is blended with H₂O. As described above, the KH₂PO₄ is mixed with H₂O in a high shear mixer for about 5 to 15 minutes to form a solution. Alternatively, the mixing time can be reduced to just a few seconds by using the continuous mixing system 1600 illustrated in FIG. 16.

Next, at step 1320, the metal oxide powder and filler material is added to the solution. As described above, the powder and filler are added slowly in order to control the reaction rate of Equation (1). Next, at step 1330, the metal oxide, filler and solution are mixed to form a flowable slurry. As described above, the metal oxide, filler and solution are mixed in high shear for approximately 8 minutes or until the resulting slurry is flowable. Alternatively, the mixing time can be reduced to just a few seconds by using the continuous mixing system 1600 illustrated in FIG. 16.

Next, at step 1340, fibers are added to the slurry. As described above, the fibers can be added in a batch process by placing the fibers in a mold and pouring the slurry into the mold. In another embodiment of the present composite cement, the fibers can be added to the slurry in a continuous process by pouring slurry onto the fibers as the fibers pass under the slurry, passing the fibers through a pair of rollers that add compressive force to the slurry and fibers, followed by a second pouring of slurry onto the fibers. The fibers then begin chemically or mechanically bonding with the slurry.

In an embodiment of the presently described technology, prior to step 1340, a wetting agent can be applied to the fibers prior to their introduction into the slurry, as described above.

At step 1350, the slurry and fiber combination is allowed to set or cure. Once the slurry cures, a composite material is formed with the ceramic concrete forming the matrix of the composite. As described above, the composite exhibits improved compressive, flexural and tensile strength over existing concretes.

Examples of inorganic composite materials and corresponding properties are provided in the following table:

| | EXAMPLE 1 | EXAMPLE 3 | EXAMPLE 3 |
|---|---|---|---|
| MgO (grams) | 280 | 280 | 280 |
| Fly Ash (grams) | 420 | 420 | 420 |
| Monopotassium | 390 | 390 | 390 |
| Phosphate (grams) | | | |
| Water (grams) | 250 | 250 | 250 |
| Basalt Fibers (% by | — | 5.3 | 5.3 |
| weight) | | | |
| Wetting | — | — | Sika AIR |
| Agent/Surfactant to | | | |
| prewet fibers | | | |
| Compression (1 day) | 10,500 psi | 10,500 psi | 10,500 psi |
| | (72,394 kPa) | (72,394 kPa) | (72,394 kPa) |
| Compression (85 days) | 15,530 psi | 15,530 psi | 15,530 psi |
| | (107,075 kPa) | (107,075 kPa) | (107,075 kPa) |
| Flexural Strength | 174 psi | 7,878 psi | 10,935 psi |
| | (1,120 kPa) | (54,317 kPa) | (75,394 kPa) |

In certain embodiments of the presently described technology, inorganic composite materials can be used in biological applications, such as bone replacements. For example, implants made from CaO-based composite can be biologically compatible with the human body.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. An inorganic composite comprising:
(a) a phosphate;
(b) a metal oxide;
(c) a filler material; and
(d) a fiber material,
wherein said phosphate, said metal oxide and said filler material are combined to form a flowable slurry, and wherein at least one of said filler material and said fiber material bonds with said flowable slurry.

2. The composite of claim 1, wherein said metal oxide is selected from the group consisting of at least one of MgO, Cu₂O, TiO₂, Al₂O₃, Fe₂O₃ and CaO.

3. The composite of claim 1, wherein at least one of said filler material and said fiber material is adapted to chemically bond with said flowable slurry.

4. The composite of claim 1, wherein said fiber material comprises at least one of basalt fibers, e-glass fibers, s-glass fibers, polytetrafluoroethylene fibers, carbon fibers, aramid fibers, ceramic fibers and metal fibers.

5. The composite of claim 1, wherein said fiber material comprises continuous fibers.

6. The composite of claim 1, wherein said fiber material comprises at least one fiber in a woven mat form.

7. A process for producing an inorganic composite, comprising:
(a) blending a phosphate with water to form a solution;
(b) mixing a metal oxide and a filler material with said solution to form a flowable slurry;
(c) coating a fiber material with said slurry in a continuous manner; and
(d) curing said slurry to form said composite.

8. The process of claim 7, wherein said metal oxide is selected from the group consisting of at least one of MgO, Cu₂O, TiO₂, Al₂O₃, Fe₂O₃ and CaO.

9. The process of claim 7, wherein at least one of said filler material and said fiber material is adapted to chemically bond with said flowable slurry.

10. The process of claim 7, wherein said fiber material comprises at least one of basalt fibers, e-glass fibers, s-glass fibers, polytetrafluoroethylene fibers, carbon fibers, aramid fibers, ceramic fibers and metal fibers.

11. The process of claim 7, wherein said fiber material comprises continuous fibers.

12. The process of claim 7, wherein said fiber material comprises at least one fiber in a woven mat form.

13. A process for production of an inorganic composite comprising:
(a) dissolving a phosphate in water to form a solution;
(b) mixing a metal oxide and a filler material with said solution at a shear rate sufficient to form a flowable slurry;
(c) coating a fiber material with said slurry in a continuous manner;
(d) applying compressive force to said slurry-coated fiber material; and
(e) curing said slurry such that said fiber material and said slurry become chemically bonded, thereby forming an integrated composite material.

14. The process of claim 13, wherein said coating is effected by continually passing said fiber material through a slurry applicator.

15. The process of claim 13, wherein said compressive force is applied by passing said fiber material between oppositely rotating rollers.

16. The process of claim 13, further comprising further coating said fiber material with said slurry after said compressive force is applied.

17. The process of claim 13, wherein said fiber material comprises a mat of woven fibers.

18. The process of claim 13, wherein said fiber material comprises at least one of basalt fibers, e-glass fibers, s-glass fibers, polytetrafluoroethylene fibers, carbon fibers, aramid fibers, ceramic fibers and metal fibers.

19. The process of claim 13, wherein at least one of said dissolving, mixing, coating, applying compressive force and curing occur under vacuum.

20. The process of claim 13, wherein said curing is effected by at least one of (1) curing said slurry while said slurry is immersed in water and (2) curing said slurry at an elevated temperature.

21. A continuous mixing system comprising:
(a) a first mixer adapted to continually dissolve a phosphate in water to form a solution;
(b) a second mixer adapted to continually mix a metal oxide and a filler with said solution to form a flowable slurry.

22. The system of claim 21, further comprising a third mixer adapted to continually mix said metal oxide and said filler with said solution.

23. The system of claim 21, further comprising a first feeder adapted to continually feed said phosphate to said first mixer.

24. The system of claim 21, further comprising a second feeder adapted to continually feed said metal oxide to said second mixer.

25. The system of claim 21, further comprising a third feeder adapted to continually feed said filler to said second mixer.

26. The system of claim 26, wherein said flowable slurry is continually pumped into a mold.

27. The system of claim 26, wherein a fiber material is inserted into said mold and wherein said flowable slurry bonds to said fiber material.
